(19) United States
(12) Patent Application Publication
(10) Pub. No.: US 2011/0103557 A1
(43) Pub. Date: May 5, 2011

(54) Overload detection on multi-CPU system

(75) Inventors: Mahesh V. Shah, Plano, TX (US); Kurt A. McIntyre, Allen, TX (US)

(73) Assignee: Alcatel-Lucent USA Inc.

(21) Appl. No.: 12/590,067

(22) Filed: Nov. 2, 2009

(51) Int. Cl. H04M 3/22; H04W 4/00

(52) U.S. Cl. 379/33; 455/466

(57) ABSTRACT

The preferred embodiment involves a multi-CPU system capable of determining whether the system as a whole is overloaded and whether each individual CPU (core) is overloaded by a single application thread. The preferred method involves sampling total CPU usage in the system by at least one software process; checking the total CPU usage for each application thread belonging to the at least one software process against at least one high water mark level if the total CPU usage in the system by the at least one software process is at or above the at least one high water mark level; indicating an overload level if the at least one high water mark level is met or exceeded by any application thread; designating the system to be in the overload level corresponding to the highest of the at least one high water mark level met or exceeded; utilizing a set of rejection rules to throttle traffic in the system based on the overload level; and beginning normal processing of traffic in the system if total CPU usage by each application thread falls to or below a low water mark level.

### CROSS REFERENCE TO RELATED APPLICATIONS

This United States non-provisional patent application does not claim priority to any United States provisional patent application or any foreign patent application.

### FIELD OF THE DISCLOSURE

The disclosures made herein relate generally to the telecommunications industry. The invention discussed herein is in the general classification of a method for detecting overload conditions in multi-central processing unit (multi-CPU) systems and a multi-CPU system that detects overload conditions on each individual CPU (core) of the multi-CPU system by any single application thread.

### BACKGROUND

This section introduces aspects that may be helpful in facilitating a better understanding of the invention. Accordingly, the statements of this section are to be read in this light and are not to be understood as admissions about what is in the prior art or what is not in the prior art.

It would be desirable for each telecommunications product to possess a way to protect itself from overload conditions. There are numerous occasions when the amount of traffic sent to a telecommunications product far exceeds the rated capacity of that product. For example, the volume of calls on December 31^{st} of each year often will far exceed the normal traffic patterns on any given piece of telecommunications equipment due to the New Year's Eve celebration. The same increased call volume also occurs on other occasions such as a presidential election night or during an emergency situation in any given region of the world.

Telecommunications systems are rated at certain capacity. For example, the telecommunications systems handing user calls may be rated at 1M (one million) Busy Hour Call Attempts (BHCA). However, several outside factors can cause much higher traffic than rated capacity. As previously discussed, a presidential election night, holiday or emergency could cause call volume to double to 2M (two million) BHCA. Without overload controls, the increased call traffic can cause outage of an entire system which would prevent any calls from being connected.

In fact, uncontrolled severe degradation may occur well below the rated capacity of any given system. The goal of any overload control is to detect increased traffic rate and throttle (discard) the additional traffic to protect the system. At a minimum, overload controls should allow a system to complete calls up to the rated capacity of the system while throttling additional traffic above rated capacity. In the above example discussed example, when total traffic is 2M BHCA, approximately one million calls will be handled successfully and the remaining one million calls will be throttled (discarded).

Currently, there is no acceptable, existing solution for detecting system overload conditions in multi-CPU systems. It would be desirable to have both a multi-CPU system capable of determining whether it is overloaded and a methodology for determining that any given multi-CPU system is overloaded.

Several technical terms will be used throughout this application and merit a brief explanation.

A central processing unit (CPU) is sometimes simply referred to as a processor. It is located in a computer system and is responsible for carrying out the instructions contained in a computer program.

A core or multi-core system refers to a processing system involving two or more independent CPUs.

A telecommunications system or system is a simply a computer, device or group of computers or devices that receive calls or other traffic, including mobile calls and text messages.

A thread is a split in a computer program that creates two or more tasks running concurrently or almost concurrently. When a system utilizes a single processor, the processor can switch between threads (multithreading) in a rapid fashion that creates the appearance that the threads/tasks are occurring at the same time. When a system utilizes multiple processors (multi-cores or cores), the threads or tasks will run at the same time with each processor (core) running a particular thread or task.

An application and a software process are used interchangeably with a computer program herein.

### SUMMARY OF THE DISCLOSURE

The best existing solution available today to handle potential overload in any telecommunications system is to monitor CPU levels in the entire system. Typically, if CPU levels are exceeding 80% or higher, then overload is declared and appropriate actions are taken.

However, with systems containing multiple CPUs (e.g. 32 CPUs), this is not an adequate methodology to insure that overload is not occurring. A system can be in overload conditions at a very low combined CPU reading if even one CPU (core) is running at full capacity while servicing one software (SW) thread. In a 32 CPU system, one fully utilized CPU represents 3.125% (100/32=3.125%) of the load. However, if the CPU is fully utilized while servicing one software thread, then it is possible to hit overload when the overall CPU reading is only 3.125% of overall capacity. This is because one software thread can only use one CPU (core) at a given time.

The preferred embodiment involves a multi-CPU system capable of determining whether the system as a whole is overloaded and whether each individual CPU (core) is overloaded by each application thread.

In alternative embodiments, the determination of overload conditions for the entire system and for each individual CPU (core) occurs at a certain percentage of traffic or total CPU usage that is lower than the rated capacity or limit of the system as a whole or for each individual CPU (core).

In alternative embodiments, different overload levels cause the system to reject a different percentage of traffic and different types of traffic. In alternative embodiments, the system begins normal processing of traffic if total CPU usage by each application thread falls below a low water mark.

The preferred method involves sampling total CPU usage in the system by at least one software process; checking the total CPU usage for each application thread belonging to the at least one software process against at least one high water mark level if the total CPU usage in the system by the at least one software process is at or above at least one high water mark level; indicating an overload level if the at least one high water mark level is met or exceeded by any application thread; designating the system to be in the overload level corresponding to the highest of the at least one high water mark level met or exceeded; utilizing a set of rejection rules to throttle traffic in the system based on the overload level; and beginning normal processing of traffic in the system if total CPU usage by each application thread falls to or below a low water mark level.

An alternative method involves throttling (discarding) traffic at a certain percentage of traffic that is lower than the rated capacity or limit of the system as a whole or for each individual CPU (core).

Under some applications, embodiments may provide the ability to protect a multi-CPU system in cases where offered traffic is higher than the rated capacity.

Under some applications, embodiments may provide the ability to protect a multi-CPU system in cases where offered traffic is a percentage of the rated capacity or limit of each individual CPU (core).

Under some applications, embodiments may provide the ability to throttle (discard) a different percentage of traffic and different types of traffic based on different overload levels.

Under some applications, embodiments may provide the ability to restore the system to normal operating conditions based on sampling of total CPU usage for each application thread.

Under some applications, embodiments may provide a method for monitoring overload conditions on the entire system and on each CPU (core).

Under some applications, embodiments may provide a method that is relatively inexpensive to implement that detects overload conditions on a multi-CPU system and on each individual CPU (core) within a multi-CPU system.

Under some applications, embodiments may provide a multi-CPU system that is relatively inexpensive to manufacture and deploy that detects overload conditions in the entire system and on each individual CPU (core) within the multi-CPU system.

Under some applications, embodiments may provide a method that efficiently detects overload conditions on a multi-CPU system and on each individual CPU (core) within a multi-CPU system.

Under some applications, embodiments may provide a reliable method that detects overload conditions on a multi-CPU system and on each individual CPU (core) within a multi-CPU system.

### BRIEF DESCRIPTION OF THE DRAWINGS

Some embodiments of apparatus and/or methods of the present invention are now described, by way of example only, and with reference to the accompanying drawings, in which:

FIG. 1 schematically illustrates a single central processing unit system processing multiple application threads.

FIG. 2 schematically illustrates a multiple central processing unit (multi-core) system processing multiple application threads.

FIG. 3 schematically illustrates a single central processing unit system processing four separate application threads.

FIG. 4 schematically illustrates a five central processing unit (5-core) system processing four separate application threads.

FIG. 5 depicts a chart showing overload conditions in a single CPU system.

FIG. 6 depicts a chart showing overload conditions in a multi-core system.

FIG. 7 depicts a four overload high water mark level and one low water mark level chart for various hardware configurations.

FIG. 8 depicts a chart of representative rejection rules based on various overload levels.

FIG. 9 depicts the method of the preferred embodiment for detecting overload conditions in a multi-CPU system and taking corrective action.

### DETAILED DESCRIPTION OF THE DRAWINGS

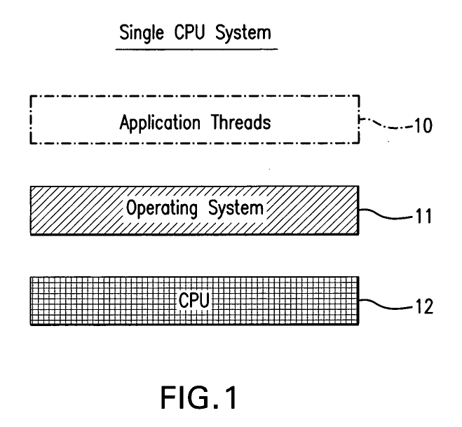

FIG. 1 schematically illustrates a single central processing unit system processing multiple application threads. The system consists of a memory 10 containing the computer instructions (software program), including application threads, a CPU 12 for processing the computer instructions, including the application threads, and an operating system 11 for scheduling the CPU 12 to allow it to be shared among multiple application threads.

Because this system utilizes a single processor (CPU 12), the processor (CPU 12) can switch between application threads (multithreading) in a rapid fashion that creates the appearance that the application threads/tasks are occurring at the same time.

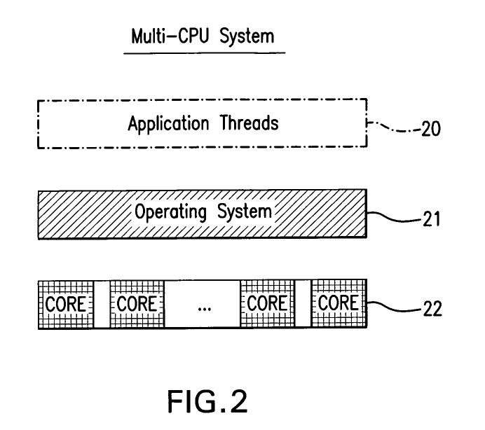

FIG. 2 schematically illustrates a multiple central processing unit (multi-core) system processing multiple application threads. The system consists of a memory 20 containing the computer instructions (software program), including application threads, multiple cores 22 for processing the computer instructions, including the application threads, and an operating system 21 for scheduling the cores 22 to allow them to be shared among multiple application threads.

Because this system utilizes multiple processors (multi-cores or cores 22), the application threads or tasks will run at the same time with each processor (core 22) running a particular thread or task.

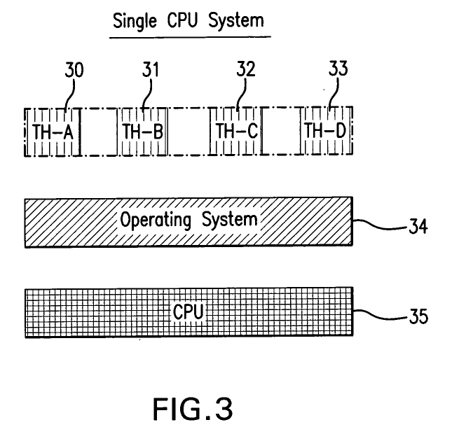

FIG. 3 schematically illustrates a single central processing unit system processing four separate application threads.

For purposes of this example, the single CPU system has a capacity of one thousand (1000) CPU cycles. The single CPU system must provide one thousand (1000) CPU cycles utilizing only a single CPU 35.

For purposes of this example, the single CPU system has a call processing application which has (4) application threads: TH-A 30, TH-B 31, TH-C 32, TH-D 33. In order to process one hundred (100) calls, TH-A 30 needs 100 CPU cycles, TH-B 31 needs 50 CPU cycles, TH-C 32 needs 30 CPU cycles, and TH-D 32 needs 20 CPU cycles. The operating system 34 schedules the CPU 35 to allow it to be shared among TH-A 30, TH-B 31, TH-C 32 and TH-D 33.

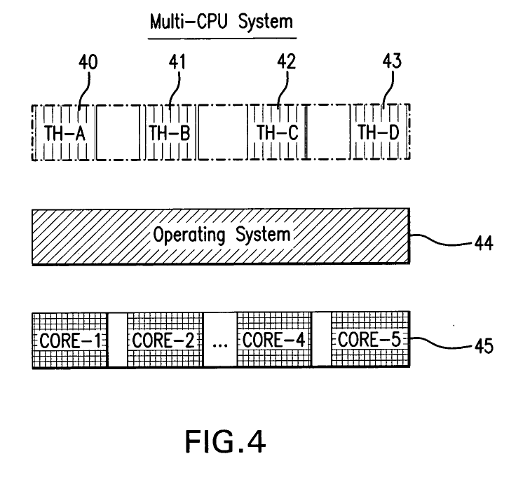

FIG. 4 schematically illustrates a five central processing unit (5-core) system processing four separate application threads.

The multi-CPU system also provides one thousand (1000) CPU cycles with 5 cores 45. Hence, each core 45 is capable of handling two hundred (200) CPU cycles (5×200 CPU cycles=1000 CPU cycles).

For purposes of this example, the multi-CPU system also has a call processing application which has four (4) application threads: TH-A 40, TH-B 41, TH-C 42, TH-D 43. In order to process one hundred (100) calls, TH-A 40 needs 100 CPU cycles, TH-B 41 needs 50 CPU cycles, TH-C 42 needs 30 CPU cycles, and TH-D 43 needs 20 CPU cycles. The operating system 44 schedules these cores 45 to allow them to be shared among TH-A 40, TH-B 41, TH-C 42 and TH-D 43.

Typically, current overload control detection methods simply measure CPU utilization in single CPU systems. If the CPU readings are higher than a certain percentage (e.g. 80% of the CPU capacity of the system), then the system is considered overloaded and appropriate actions can be taken. This methodology is adequate when there is only one CPU that is shared among all application threads.

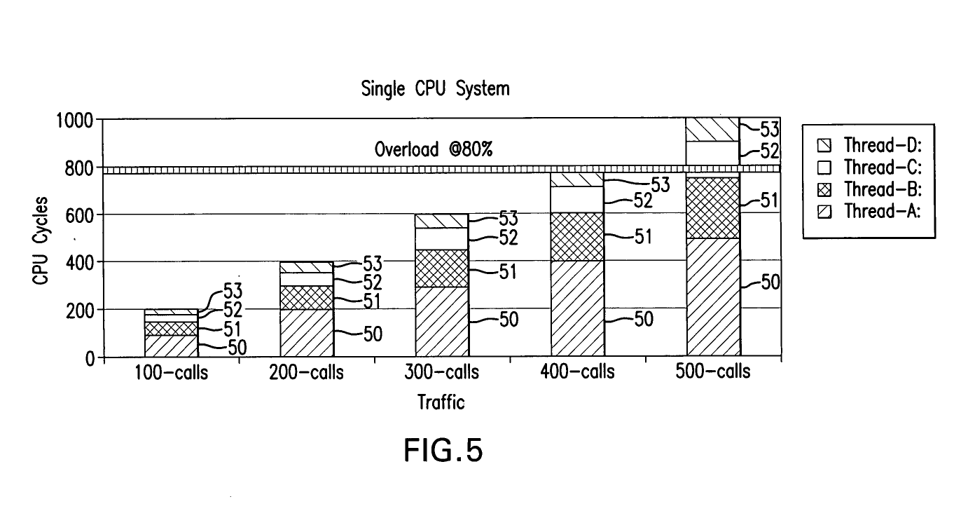

FIG. 5 depicts a chart showing overload conditions in a single CPU system. In such a set-up, the application threads (TH-A 50, TH-B 51, TH-C 52, TH-D 53) take turns running on a single CPU. In this example, TH-A 50 takes the most number of CPU cycles while TH-D 53 takes the fewest number of CPU cycles. CPU usage grows linearly with traffic (e.g. calls). In this example, the CPU has a maximum capacity of one thousand (1000) CPU cycles.

To process 100 calls, TH-A 50 needs 100 CPU cycles, TH-B 51 needs 50 CPU cycles, TH-C 52 needs 30 CPU cycles, and TH-D 53 needs 20 CPU cycles for a total of 200 CPU cycles.

To process 200 calls, TH-A 50 needs 200 CPU cycles, TH-B 51 needs 100 CPU cycles, TH-C 52 needs 60 CPU cycles, and TH-D 53 needs 40 CPU cycles for a total of 400 CPU cycles.

To process 300 calls, TH-A 50 needs 300 CPU cycles, TH-B 51 needs 150 CPU cycles, TH-C 52 needs 90 CPU cycles, and TH-D 53 needs 60 CPU cycles for a total of 600 CPU cycles.

To process 400 calls, TH-A 50 needs 400 CPU cycles, TH-B 51 needs 200 CPU cycles, TH-C 52 needs 120 CPU cycles, and TH-D 53 needs 80 CPU cycles for a total of 800 CPU cycles.

At 400 calls, the CPU reaches eighty percent (80%) of CPU capacity which, in this example, is designated as an overload condition because degradation of service occurs above this percentage. In this example, a simple measurement of the single CPU alone provides meaningful and sufficient data to detect overload in a single CPU system.

To process 500 calls, TH-A 50 needs 500 CPU cycles, TH-B 51 needs 250 CPU cycles, TH-C 52 needs 150 CPU cycles, and TH-D 53 needs 100 CPU cycles for a total of 1000 CPU cycles. While in this example, the CPU has the capacity to run one thousand (1000) CPU cycles, this would be an undesirable traffic load for the system because of the degradation of service above the eighty percent threshold discussed herein.

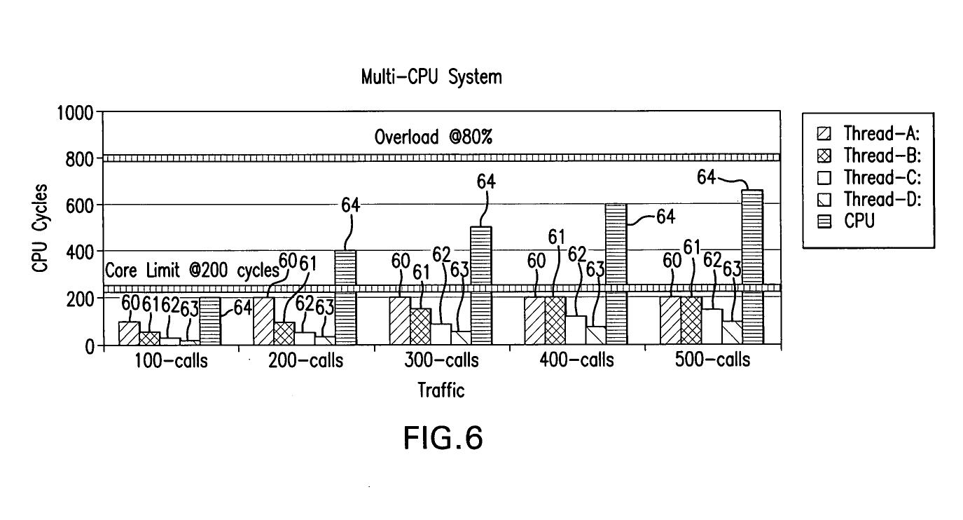

FIG. 6 depicts a chart showing overload conditions in a multi-core system. In this example, TH-A 60 takes the most number of CPU cycles while TH-D 63 takes the fewest number of CPU cycles. CPU usage grows linearly with traffic (e.g. calls). In this example, the total CPU has a maximum capacity of one thousand (1000) CPU cycles and each core has a limit of 200 CPU cycles. Each application thread receives a dedicated core as there are four threads and five cores in this example.

To process 100 calls, TH-A 60 needs 100 CPU cycles, TH-B 61 needs 50 CPU cycles, TH-C 62 needs 30 CPU cycles, and TH-D 63 needs 20 CPU cycles for a total of 200 CPU cycles 64.

To process 200 calls, TH-A 60 needs 200 CPU cycles, TH-B 61 needs 100 CPU cycles, TH-C 62 needs 60 CPU cycles, and TH-D 63 needs 40 CPU cycles for a total of 400 CPU cycles 64.

To process 300 calls, TH-A 60 would need 300 CPU cycles, however, this is greater than the maximum capacity of an individual core (only 200 CPU cycles are possible). TH-B 61 needs 150 CPU cycles, TH-C 62 needs 90 CPU cycles, and TH-D 63 needs 60 CPU cycles for a total of 500 CPU cycles 64.

To process 400 calls, TH-A 60 would need 400 CPU cycles, however this is greater than the maximum capacity of an individual core (only 200 CPU cycles are possible). TH-B 61 needs 200 CPU cycles, TH-C 62 needs 120 CPU cycles, and TH-D 63 needs 80 CPU cycles for a total of 600 CPU cycles 64.

To process 500 calls, TH-A 60 would need 500 CPU cycles, however, this is greater than the maximum capacity of an individual core (only 200 CPU cycles are possible). TH-B 61 would need 250 CPU cycles, however, this is also greater than the maximum capacity of an individual core (only 200 CPU cycles are possible). TH-C 62 needs 150 CPU cycles, and TH-D 63 needs 100 CPU cycles for a total of 650 CPU cycles 64.

As shown in FIG. 6, at 200 calls of traffic, TH-A 60 uses one core completely (i.e. 100% of one of five cores). At 300 calls of traffic, TH-A 60 needs 300 cycles to process all 300 calls, but since it can only run on one core, it is limited to 200 cycles. Hence, the system is in overload conditions above 200 calls while utilizing only 400 of 1000 total CPU cycles. The multi-CPU system reaches overload condition when the overall/total CPU cycle usage is at forty percent (40%-400 CPU cycles out of a possible 1000 CPU cycles) which is well below the eighty percent (80%) level traditionally used for declaring overload on the entire system.

The traditional overload detection methods used for declaring an overload of traffic in a single CPU system are not sufficient for multi-CPU systems. For multi-CPU systems, it is necessary to monitor individual threads and check the condition of a single thread using one hundred percent (100%) of one core to detect overload.

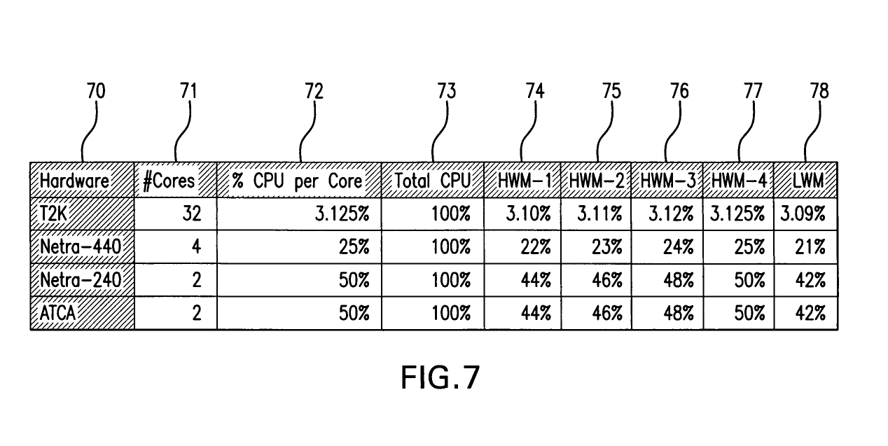

FIG. 7 depicts a four overload high water mark level and one low water mark level chart for various hardware configurations. The type of hardware/system 70, number of cores 71 for a given type of hardware 70, the percentage of total CPU used per core 72, the total CPU 73, HWM-1 74 (high water mark level 1), HWM-2 75, HWM-3 76, HWM-4 77 and low water mark level (LWM) 78 are shown in FIG. 7. Four overload high water mark (HWM) levels and one low water mark (LWM) level, in this example, are configured for any given hardware configuration.

In this preferred embodiment, software installed on the system periodically (e.g. every 3-seconds) samples total CPU usage by each software process. Any given software process may contain multiple application threads. If the software process is above any given HWM for a given hardware type, then the application threads belonging to this software process are checked against the HWM. If, for example, a sample set (e.g. five (5) consecutive samples) is above any of the HWMs for a given thread, then overload is declared.

For example, if thread number ten (10) of software process two (2) is using between 3.11% (HWM-2) and 3.12% (HWM-3) of the total CPU for a T2K system, then overload level two (2) is declared. The overload level corresponds with the highest high water mark level met or exceeded in this example. If no thread is at or above the lowest high water mark level, normal processing occurs and sampling continues.

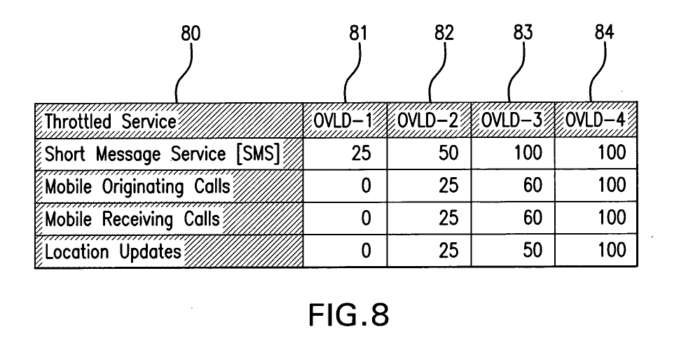

FIG. 8 depicts a chart of representative rejection rules based on various overload levels. The numbers are expressed in terms of percentages. Based on the overload level (OVLD-1 81, OVLD-2 82, OVLD-3 83 and OVLD-4 84) and configured rejection rules, call throttling (throttling service 80) can take place. For example, in OVLD-1 81, 1 out of every 4 (25%) text messages or short message service (SMS) will be dropped. Because OVLD-1 81 is a lower overload level, there will not be any impact on other service types such as mobile originating calls, mobile receiving calls and location updates.

In another example, in OVLD-3 83, the system will reject all (100%) SMSs, sixty percent (60%) of mobile originating calls and mobile receiving calls and fifty percent (50%) of location updates. Because OVLD-3 83 is a higher level overload, more services and a higher percentage of each of those services are affected.

If a sample set (e.g. five (5) consecutive samples) registers below the LWM level for each thread as discussed in conjunction with FIG. 7, then the system is declared out of overload and normal processing begins again, meaning all services can be processed in their entirety.

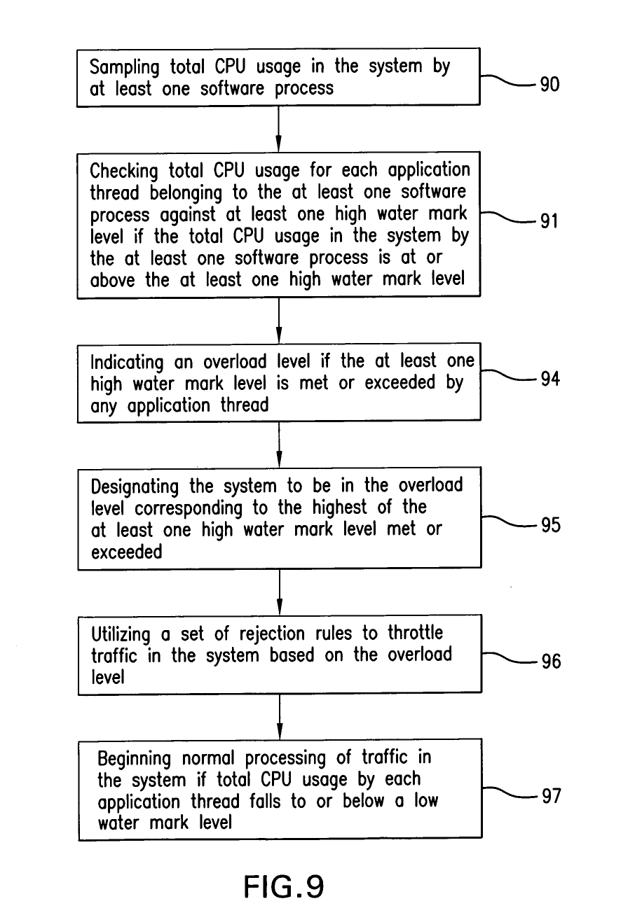

FIG. 9 depicts the method of the preferred embodiment for detecting overload conditions in a multi-CPU system and taking corrective action. An operation for sampling total CPU usage in the system by at least one software process 90 is performed. Total CPU usage may be measured in terms of a percentage used of total CPU capacity (capacity of all cores in the aggregate). Then, an operation is performed for checking the total CPU usage for each application thread belonging to the at least one software process against at least one high water mark level if the total CPU usage in the system by the at least one software process is at or above the at least one high water mark level 91. An operation for indicating an overload level if the at least one high water mark level is met or exceeded 94 by any application thread is then performed. Then, an operation for designating the system to be in the overload level corresponding to the highest of the at least one high water mark level met or exceeded 95 is performed. An operation for utilizing a set of rejection rules to throttle traffic in the system based on the overload level 96 is performed and an operation for beginning normal processing of traffic in the system if total CPU usage by each application thread falls to or below a low water mark level 97 is performed. Alternatively, normal processing may occur if the total CPU usage by each application thread falls below the lowest high water mark level.

In certain alternative embodiments, a method for detecting overload conditions on a multi-central processing unit (CPU) system may simply involve sampling total CPU usage by each application; checking the total CPU usage by each application against at least one high water mark level; utilizing a set of rejection rules to throttle traffic in the system if any one of the at least one high water mark level is met or exceeded; and beginning normal processing of traffic in the system if total CPU usage by each application falls to or below a low water mark level.

It is contemplated that the method described herein can be implemented as software, including a computer-readable medium having program instructions executing on a computer, hardware, firmware, or a combination thereof. The method described herein also may be implemented in various combinations on hardware and/or software.

A person of skill in the art would readily recognize that steps of the various above-described methods can be performed by programmed computers and the order of the steps is not necessarily critical. Herein, some embodiments are intended to cover program storage devices, e.g., digital data storage media, which are machine or computer readable and encode machine-executable or computer executable programs of instructions where said instructions perform some or all of the steps of methods described herein. The program storage devices may be, e.g., digital memories, magnetic storage media such as magnetic disks or taps, hard drives, or optically readable digital data storage media. The embodiments are also intended to cover computers programmed to perform said steps of methods described herein.

It will be recognized by those skilled in the art that changes or modifications may be made to the above-described embodiments without departing from the broad inventive concepts of the invention. It should therefore be understood that this invention is not limited to the particular embodiments described herein, but is of the invention as set forth in the claims.

What is claimed is:

1. A multi-central processing unit (CPU) system capable of detecting overload conditions comprising:
(a) a memory containing instructions for sampling total CPU usage in the system by at least one software process and checking total CPU usage for each application thread belonging to the at least one software process against at least one high water mark level if the total CPU usage in the system by the at least one software process is at or above the at least one high water mark level;
(b) a set of cores for processing the instructions; and
(c) an operating system for scheduling the set of cores.

2. The system of claim 1 wherein sampling total CPU usage in the system by the at least one software process occurs every three seconds.

3. The system of claim 1 wherein checking total CPU usage for each application thread is done by using a sample set.

4. The system of claim 1 wherein the memory also contains instructions for indicating an overload level if the total CPU usage of any application thread meets or exceeds at least one high water mark level.

5. The system of claim 4 wherein indicating an overload level is done by designating the system to be in the overload level corresponding to the highest of the at least one high water mark level met or exceeded.

6. The system of claim 4 wherein the memory also contains instructions for utilizing a set of rejection rules to throttle traffic in the system based on the overload level.

7. The system of claim 6 wherein the memory also contains instructions for beginning normal processing of traffic in the system if total CPU usage by each application thread falls below a low water mark level.

8. A method for detecting overload conditions on a multi-central processing unit (CPU) system comprising the steps of:
(a) sampling total CPU usage in the system by at least one software process; and
(b) checking total CPU usage for each application thread belonging to the at least one software process against at least one high water mark level if the total CPU usage in the system by the at least one software process is at or above the at least one high water mark level.

9. The method of claim 8 wherein sampling total CPU usage in the system by the at least one software process occurs every three seconds.

10. The method of claim 8 wherein checking total CPU usage for each application thread involves using a sample set.

11. The method of claim 10 wherein the sample set is five consecutive samples of total CPU usage for each application thread.

12. The method of claim further 8 comprising the step of:
indicating an overload level if the at least one high water mark level is met or exceeded by any application thread.

13. The method of claim 12 wherein indicating the overload level involves designating the system to be in the overload level corresponding to the highest of the at least one high water mark level met or exceeded.

14. The method of claim 13 further comprising the step of:
utilizing a set of rejection rules to throttle traffic in the system based on the overload level.

15. The method of claim 14 wherein there are four high water mark levels.

16. The method of claim 15 wherein a first overload level causes the system to throttle twenty-five percent of text messages (short message service).

17. The method of claim 15 wherein a second overload level causes the system to throttle fifty percent of text messages (SMSs) and twenty-five percent of mobile originating calls, mobile receiving calls and location updates.

18. The method of claim 15 wherein a third overload level causes the system to throttle one hundred percent of text messages (SMSs), sixty percent of mobile originating calls and mobile receiving calls and fifty percent of location updates.

19. The method of claim 15 wherein a fourth overload level causes the system to throttle one hundred percent of text messages (SMSs), mobile originating calls, mobile receiving calls and location updates.

20. The method of claim 14 further comprising the step of:
beginning normal processing of traffic in the system if total CPU usage by each application thread falls to or below a low water mark level.

21. A method for detecting overload conditions on a multi-central processing unit (CPU) system comprising the steps of:
(a) sampling total CPU usage in the system by each application;
(b) checking the total CPU usage by each application against at least one high water mark level; and
(c) utilizing a set of rejection rules to throttle traffic in the system if the total CPU usage by any application meets or exceeds the at least one high water mark level.

22. The method of claim 21 further comprising the steps of:
beginning normal processing of traffic in the system if total CPU usage by each application falls to or below a low water mark level.
